(19) United States
(12) Patent Application Publication
(10) Pub. No.: US 2024/0103513 A1
(43) Pub. Date: Mar. 28, 2024

(54) SYSTEMS AND METHODS FOR DYNAMIC CONTROL OF REMOTELY OPERATED VEHICLES BASED ON ENVIRONMENT CONDITIONS

(71) Applicant: Vay Technology GmbH, Berlin (DE)

(72) Inventors: Karsten Gordon, Ringsee (DE); Shilp Dixit, Berlin (DE); Mathias Metzler, Frankfurt am Main (DE)

(21) Appl. No.: 17/951,759

(22) Filed: Sep. 23, 2022

(51) Int. Cl. G05D 1/00; B60W 50/16

(52) U.S. Cl. CPC G05D 1/0038; B60W 50/16; B60W 2050/143

(57) ABSTRACT

Systems and methods for dynamic control of remotely operated vehicles may include various types of sensors to detect environment, surface, and/or friction conditions proximate a vehicle. Based on the detected environment, surface, and/or friction conditions, a maximum acceleration for safe operation of the vehicle may be determined. In addition, various dynamic control limits or ranges for the vehicle may be determined based on the maximum acceleration, and the vehicle may be controlled or instructed to operate within such dynamic limits. Moreover, various notifications, alerts, and/or feedback may be presented or output for the teleoperator at the teleoperator station in order to increase environment awareness and promote safe driving behaviors.

### BACKGROUND

Teleoperated remote driving of a vehicle may be considered a transient technology toward fully autonomous driving. In such remote driving applications, a teleoperator may use a teleoperator station to remotely drive the vehicle via a wireless communication network. To facilitate such remote driving applications, a live video stream representing a view of the vehicle's environment may be captured, transmitted, and presented to a teleoperator at the teleoperator station. However, the live video stream may provide limited awareness of the environment around the vehicle, including temperature, precipitation, other weather conditions, driving conditions, surface or friction conditions, or others. Accordingly, there is a need for systems and methods to ensure safe driving behaviors and increase environment awareness to enable safe and reliable teleoperated remote driving of vehicles.

### BRIEF DESCRIPTION OF THE DRAWINGS

FIG. 1 is a schematic diagram of an example remote driving system, in accordance with implementations of the present disclosure.

FIG. 2 is a schematic diagram of an example vehicle adapted for remote driving applications, in accordance with implementations of the present disclosure.

FIG. 3 is a schematic diagram of an example video data including notifications related to dynamic remote operation based on driving conditions, in accordance with implementations of the present disclosure.

FIG. 4 is a flow diagram illustrating an example dynamic remote operation based on driving conditions process, in accordance with implementations of the present disclosure.

FIG. 5 is a schematic diagram of an example video data including feedback to increase environment awareness based on driving conditions, in accordance with implementations of the present disclosure.

FIG. 6 is a flow diagram illustrating an example increased environment awareness during remote operation process, in accordance with implementations of the present disclosure.

### DETAILED DESCRIPTION

As is set forth in greater detail below, implementations of the present disclosure are directed to systems and methods to dynamically control remote operation of vehicles based on environment conditions, thereby ensuring safe driving behaviors to enable safe and reliable teleoperated remote driving of vehicles. In addition, implementations of the present disclosure are directed to systems and methods to increase environment awareness of teleoperators at teleoperator stations who are operating remote vehicles, thereby enabling safe and reliable teleoperated remote driving of vehicles.

In example embodiments of remote driving applications, a teleoperator may use a teleoperator station to remotely drive a vehicle within an environment via a wireless communication network. One or more imaging devices or sensors associated with the vehicle may capture a live video stream representing a view of the vehicle's environment. The live video stream may then be transmitted, processed, and presented to a teleoperator at the teleoperator station. At the teleoperator station, the teleoperator may view the live video stream and remotely drive the vehicle by using a control interface of the teleoperator station to generate drive control commands. Then, the drive control commands may be processed and transmitted from the teleoperator station to the vehicle, and the vehicle may receive, process, and execute the drive control commands.

Generally, it may be difficult or challenging for a teleoperator at a teleoperator station to understand or have full awareness of environment conditions in the environment proximate the vehicle because the teleoperator and teleoperator station may be remote from the vehicle. For example, weather conditions proximate the teleoperator station may be very different from weather conditions proximate the vehicle. In addition, changes to surface and/or friction conditions due to weather conditions proximate the vehicle may not be fully understood or may be underestimated by the teleoperator. Further, weather, surface, and/or friction conditions in the environment proximate the vehicle may change or vary over time during remote operation by the teleoperator.

In example embodiments, the vehicle may include various types of sensors to capture data associated with the environment, such as environment sensors, weather sensors, temperature sensors, humidity sensors, radar sensors, light detection and ranging (LIDAR) sensors, other types of time of flight sensors, imaging sensors, depth sensors, infrared sensors, other types of imaging sensors, vehicle dynamics sensors, audio sensors, and/or various other types of sensors. Various data captured by one or more sensors onboard the vehicle may be processed to dynamically control remote operation of the vehicle based on environment conditions, as well as to provide, present, emit, or output notifications or feedback related to the environment conditions to the teleoperator to increase environment awareness.

In example embodiments, data from various environment, weather, temperature, or related sensors may be processed to determine environment conditions, surface conditions, and/or friction conditions associated with the environment proximate the vehicle, such as friction or traction conditions between a surface of a roadway and tires of the vehicle. Based on the determined environment, surface, and/or friction conditions, a maximum deceleration of the vehicle within the environment may be determined.

In addition, data from various time of flight, imaging, vehicle dynamics, or related sensors may be processed to determine a distance to an object along a movement direction of the vehicle and/or a current speed of the vehicle along the movement direction. Then, based on the maximum deceleration of the vehicle, the distance to the object, and/or the current speed, a maximum speed and/or a minimum safe stopping distance may be determined for the vehicle. Further, the vehicle may be dynamically controlled to operate based on at least one of the maximum deceleration, the maximum speed, and/or the minimum safe stopping distance, thereby ensuring safe driving behaviors to enable safe and reliable teleoperated remote driving of vehicles.

In additional example embodiments, one or more notifications or alerts may be provided, presented, output, or emitted to a teleoperator at the teleoperator station, such as visual, audio, and/or haptic notifications based on the environment, surface, and/or friction conditions. The notifications may be related to the maximum deceleration, the maximum speed, and/or the minimum safe stopping distance to inform the teleoperator of safe driving behaviors based on the environment, surface, and/or friction conditions.

In further example embodiments, various feedback based on the environment data may also be provided, presented, output, or emitted for a teleoperator at the teleoperator station to increase environment awareness. The various feedback may comprise various types of visual, audio, and/or haptic feedback.

For example, visual feedback may include visual cues, icons, or other alerts related to environment or weather conditions that may be presented via a presentation device at the teleoperator station. In addition, operation of various components based on the environment or weather conditions, such as windshield wipers, defroster, defogger, or other components, may be simulated and presented via a presentation device to increase environment awareness.

Moreover, audio feedback may include tones, sounds, or alerts related to environment or weather conditions that may be emitted via a presentation device or audio output devices at the teleoperator station. Furthermore, sounds or noises based on the environment or weather conditions, such as raindrops, hail, other precipitation, wind, tire noise while moving through water and/or snow, tire noise while traveling upon gravel, dirt, or other loose terrain, or other sounds, may be simulated and output via a presentation device or audio output devices to increase environment awareness.

Further, haptic feedback may include vibration, oscillation, or other haptic feedback that may be output via one or more components of the control interface at the teleoperator station based on the environment data, which may simulate vehicle sliding or loss of traction, braking assistance systems, lane keeping assistance systems, or other similar systems. In addition, aspects related to the environment data, such as temperature, precipitation, humidity, or other environment or weather conditions, may be simulated and output at the teleoperator station to increase environment awareness.

By the systems and methods described herein, remote operation of vehicles may be dynamically controlled based on environment data, such as environment, surface, and/or friction conditions, thereby ensuring safe and reliable operation of remotely operated vehicles. In addition, various notifications, alerts, sounds, or other indications associated with safe driving behaviors may be provided, presented, and/or emitted to a teleoperator at a teleoperator station, thereby increasing safety associated with the remote operation of the vehicle. Further, various types of visual, audio, and/or haptic feedback associated with or simulating environment conditions proximate the remotely driven vehicle may be provided, presented, emitted, and/or output to a teleoperator at a teleoperator station, thereby increasing environment awareness to ensure safe driving behaviors during the remote operation of the vehicle.

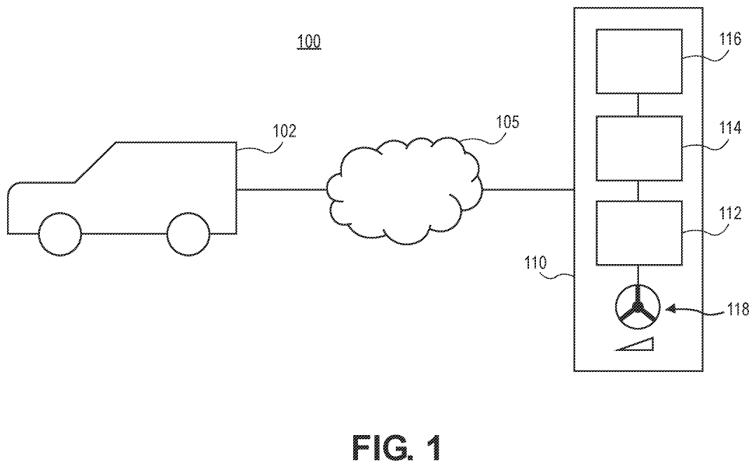

FIG. 1 is a schematic diagram 100 of an example remote driving system, in accordance with implementations of the present disclosure.

As shown in FIG. 1, the example remote driving system may comprise a vehicle 102 that is adapted to be remotely driven, controlled, or instructed by a teleoperator via a wireless communication network 105. In addition, the example remote driving system may comprise a teleoperator station 110 for use by a teleoperator to remotely drive, control, or instruct the vehicle 102 via the wireless communication network 105.

In example embodiments, the vehicle 102 may comprise a car, such as a small car, a regular car, a Sports Utility Vehicle (SUV), a van, a truck, or any other type of vehicle that is adapted to be remotely driven, controlled, or instructed. As further described herein, the vehicle 102 may be defined or described in terms of a longitudinal axis of the vehicle that extends between a forward nose or portion of the vehicle and a rearward tail or portion of the vehicle, and the longitudinal axis may generally extend in a straight line parallel to directions of forward and rearward motion of the vehicle. Further, the vehicle 102 may be defined or described in terms of a lateral or transverse axis of the vehicle that extends between a left lateral side of the vehicle and a right lateral side of the vehicle, and the lateral or transverse axis may generally extend substantially transverse, orthogonal, or perpendicular to the longitudinal axis of the vehicle.

In addition, the vehicle 102 may comprise a modified vehicle that includes or provides the required on-board infrastructure for teleoperation. For example, the vehicle 102 may include actuators for controlling the vehicle 102, one or more imaging devices, cameras, or sensors, depth sensors, infrared sensors, or other types of imaging sensors for capturing imaging data of the vehicle's environment, one or more environment sensors, weather sensors, temperature sensors, humidity sensors, or other types of environment sensors for detecting or capturing data associated with the vehicle's environment, one or more audio sensors or arrays, radar sensors, light detection and ranging (LIDAR) sensors, other types of time of flight sensors, or other types of sensors for detecting or capturing data associated with the vehicle's environment and/or objects proximate the vehicle, one or more vehicle dynamics sensors for detecting or measuring drive state information or vehicle operational characteristics, and/or various interfaces for bi-directional communication with the teleoperator station 110 via the wireless communication network 105.

The actuators for controlling the vehicle 102 may include mechanical actuators that directly actuate the vehicle's steering wheel, acceleration pedal, brakes, and/or other systems or components of the vehicle 102. Alternatively, existing actuators of the vehicle 102 (e.g., for adjusting or controlling speed, acceleration, steering angle, and/or other operational characteristics) may be controlled via an electronic interface associated with the vehicle 102.

The imaging devices, cameras, or sensors, or other types of imaging sensors associated with the vehicle 102 may comprise various types of imaging sensors, analog cameras, digital cameras, video cameras, depth sensors, infrared sensors, or other types of imaging sensors. The imaging devices or cameras may be positioned and oriented at various positions on the vehicle 102 in order to capture imaging data of an environment at least partially around the vehicle 102, e.g., towards a forward movement direction, towards a rearward movement direction, and/or toward various other portions of a periphery of the vehicle 102. In addition, the imaging devices or cameras may capture imaging data, such as video data, live video streams, or other types of imaging data, which may be transmitted to the teleoperator station 110 and used to determine environment conditions and dynamic control limits, as well as increase environment awareness, as further described herein.

Further, the radar, LIDAR, or other time of flight sensors, as well as imaging sensors, such as stereo imaging sensors or depth sensors, may capture data associated with one or more objects in proximity to the vehicle, such as vehicles, people, bicycles, obstacles, obstructions, or various other types of objects. In some example embodiments, the time of flight and/or imaging sensors may detect distance data related to one or more objects proximate the vehicle, e.g., along a movement direction of the vehicle, in order to prevent collisions or interference with the objects. The distance or ranging data may be transmitted to the teleoperator station 110, and may be used to determine environment conditions and dynamic control limits, as well as increase environment awareness, as further described herein.

The environment sensors, weather sensors, temperature sensors, humidity sensors, or other types of environment sensors may detect or measure environment data related to aspects of the environment, including weather, temperature, precipitation, humidity, moisture, driving surface type, surface material properties, tire properties, or other aspects. The environment sensors may comprise various types of sensors, such as imaging sensors, infrared sensors, thermometers, hygrometers, moisture sensors, optical sensors, laser sensors, acoustic sensors, and/or other types of sensors.

In some example embodiments, one or more environment sensors, such as optical, laser, or acoustic sensors, may be positioned or oriented to detect or measure aspects related to roadways, surface conditions, and/or tires, including surface type, material properties, moisture, tire properties, or other aspects. For example, optical or laser sensors may detect surface characteristics of a surface of a roadway and/or tires, and the surface characteristics may relate to color, reflectivity, thermal properties, material or chemical properties, and/or various other optical or visual characteristics of surfaces of roadways and/or tires. In addition, acoustic sensors may detect sounds, noise, or other acoustic signals due to contact between tires and a surface of a roadway, and the sounds or other acoustic signals may be associated with tire noise on smooth surfaces, tire noise on loose terrain, tire noise on dry surfaces, tire noise on wet or slippery surfaces, tire noise on snowy or icy surfaces, tire noise associated with other surface characteristics, and/or combinations thereof.

Further, such detected or measured aspects related to roadways, surface conditions, and/or tires may be processed using various machine learning algorithms or techniques to determine associated coefficients of friction based on the environment conditions. The environment data may be transmitted to the teleoperator station 110, and may be used to determine environment conditions and dynamic control limits, as well as increase environment awareness, as further described herein.

The audio sensors or arrays associated with the vehicle 102 may comprise various types of microphones, microphone arrays, audio transducers, piezoelectric elements, and/or other types of audio sensors. The audio sensors or arrays may be positioned and oriented at various positions on the vehicle 102 in order to detect and capture audio data of an environment at least partially around the vehicle 102. In addition, the audio sensors or arrays may capture audio data, such as sounds associated with various types of precipitation, wind, noise associated with tires traveling over water and/or snow, noise associated with tires traveling over gravel, dirt, or loose terrain, and/or other sounds or noises related to aspects of the environment, surface, or friction conditions proximate the vehicle, which may be transmitted to the teleoperator station 110 and used to determine environment conditions and dynamic control limits, as well as increase environment awareness, as further described herein.

The vehicle dynamics sensors for detecting or measuring drive state information or vehicle operational characteristics of the vehicle 102 may comprise various types of sensors configured to detect speed, acceleration, steering angle, and/or other operational characteristics of the vehicle 102. For example, a first sensor such as a speedometer or encoder may measure a drive speed and/or wheel rotation of the vehicle 102, a second sensor such as an accelerometer, pressure sensor, or encoder may measure pedal actuation, acceleration, deceleration, or braking of the vehicle 102, and/or a third sensor such as an encoder or position/orientation sensor may measure a steering state or angle of the steering wheel and/or measure an orientation of the vehicle wheels. In addition, one or more tires or wheels of the vehicle 102 may include embedded or integral sensors to detect or measure rotation rates, acceleration, load, stress, strain, traction, slip, tread depth, pressure, temperature, or other aspects related to movement and traction of the tires. The drive state information or vehicle dynamics data of the vehicle 102 related to vehicle operational characteristics may be transmitted to the teleoperator station 110, and may be used to determine environment conditions and dynamic control limits, as well as increase environment awareness, as further described herein.

The interfaces for bi-directional communication with the teleoperator station 110 may enable transmission of imaging data, ranging data, environment data, audio data, other sensor data, vehicle data, and/or various other data, as well as transmission of drive state information associated with the vehicle 102, from the vehicle 102 to the teleoperator station 110 via the wireless communication network 105. In addition, the interfaces for bi-directional communication with the teleoperator station 110 may enable receipt of drive control commands, dynamic control limits or ranges, partially or substantially fully autonomous drive commands or instructions, and/or other data, information, commands, or instructions from the teleoperator station 110 via the wireless communication network 105.

In example embodiments, the wireless communication network 105 may comprise a network that allows for bi-directional transmission of data between the vehicle 102 and the teleoperator station 110. For example, the network 105 may be a fourth generation (4G) wireless communication network, a fifth generation (5G) wireless communication network, or other types of wireless communication networks.

Various data or information may be transmitted via the network 105, including imaging data, ranging data, environment data, audio data, other sensor data, vehicle data, drive state information, and/or various other data associated with the vehicle 102, e.g., from the vehicle 102 to the teleoperator station 110, as well as drive control commands, dynamic control limits or ranges, partially or substantially fully autonomous drive commands or instructions, and/or other data, information, commands, or instructions, e.g., from the teleoperator station 110 to the vehicle 102 via the wireless communication network 105. The drive state information may comprise data or information related to speed, acceleration, steering angle, and/or other operational data or characteristics associated with the vehicle 102. In addition, the drive control limits or ranges may comprise data or information related to maximum speeds, maximum acceleration or deceleration, minimum safe stopping distances, maximum steering angles, various combinations thereof, and/or other operational commands, instructions, or changes associated with the vehicle 102. Further, additional data may be exchanged between the vehicle 102 and the teleoperator station 110, such as imaging data, video data, live stream data, and/or time synchronization information including data transmission timestamps.

In example embodiments, the teleoperator station 110 may comprise a communication unit 112 configured to send and receive data or information to and from the vehicle 102 via the network 105, a processor or processing unit 114 configured to process various data and dynamically control remote operation of the vehicle 102 based on environment conditions, and/or generate notifications, alerts, or feedback to a teleoperator based on the environment conditions, a presentation or display device 116 configured to present, emit, or output the imaging data, visual, audio, or haptic notifications or alerts related to safe driving behaviors, and/or visual, audio, or haptic feedback based on environment conditions to a teleoperator using the teleoperator station 110, and a control interface 118 configured to receive drive control commands and/or other inputs or instructions from the teleoperator using the teleoperator station 110.

The communication unit 112 may comprise various types of communication systems, devices, antenna, interfaces, or other data transmit/receive units configured to enable wireless communication between the teleoperator station 110 and the vehicle 102 via the wireless communication network 105. As described herein, the communication unit 112 may receive imaging data, ranging data, environment data, audio data, other sensor data, vehicle data, drive state information, and/or various other data from the vehicle 102, and may transmit drive control commands, drive control limits or ranges, partially or substantially fully autonomous drive commands or instructions, and/or other data to the vehicle 102.

The processor 114 may comprise a processing unit, graphics processing unit, or other types of processors configured to process the various data that is received and/or sent between the vehicle 102 and teleoperator station 110 via the network 105. For example, as further described herein, the processor 114 may receive environment data, process the environment data to determine surface and/or friction conditions proximate the vehicle, and determine one or more of a maximum deceleration, a maximum speed, a minimum safe stopping distance, a maximum steering angle, and/or other limits or ranges related to dynamic control of remote operation. In addition, as further described herein, the processor 114 may also receive imaging data, ranging data, audio data, and/or vehicle dynamics data to facilitate determination of dynamic control limits or ranges for remote operation of the vehicle based on the environment data.

Furthermore, as described herein, the processor 114 may receive imaging data, e.g., video data or live video streams, generate one or more notifications or alerts based on the dynamic control limits or ranges, and present or output the notifications or alerts based on the dynamic control limits or ranges with the imaging data of the environment. Moreover, as further described herein, the processor 114 may also generate various feedback based on the environment data, and provide or output the feedback to a teleoperator at the teleoperator station to increase environment awareness.

In addition, as further described herein, the processor 114 may command or instruct various actions by the vehicle based on the dynamic control limits or ranges to ensure safe driving behaviors. In addition, the processor 114 may receive and process drive control commands received from a teleoperator associated with the teleoperator station 110, such that the drive control commands can be transmitted to the vehicle 102 via the network 105 in order to remotely drive, control, or instruct various systems or components of the vehicle 102.

The presentation device 116 may comprise one or more monitors, screens, projectors, display devices, head-mounted displays, augmented reality displays, other types of presentation devices, speakers, audio output devices, haptic feedback devices or output devices, and/or other types of feedback or output devices.

For example, the one or more monitors, screens, projectors, or displays may receive and present, render, or display the imaging data, e.g., video data or live video streams, received from the vehicle 102. In addition, the one or more monitors, screens, projectors, or displays may receive notifications, alerts, or other visual indicators generated by the processor 114 based on the dynamic control limits or ranges and/or environment data, and may present, render, or overlay the notifications, alerts, or other visual indicators within or onto the imaging data. Further, the one or more monitors, screens, projectors, or displays may receive visual feedback, such as cues, icons, simulations, or other indicators, generated by the processor 114 based on the environment data, and may provide, output, or emit the visual feedback to the teleoperator at the teleoperator station to increase environment awareness.

In addition, the one or more speakers or audio output devices may receive sounds, noises, alerts, or other audio data generated by the processor 114 based on the dynamic control limits or ranges and/or environment data, and may emit or output the sounds, noises, alerts, or other audio data at the teleoperator station. Further, the one or more speakers or audio output devices may receive audio feedback, such as sounds, noises, simulated noise, or other audio data, generated by the processor 114 based on the environment data, and may provide, output, or emit the audio feedback to the teleoperator at the teleoperator station to increase environment awareness.

Moreover, the one or more haptic feedback devices or other output devices may receive notifications, alerts, vibrations, oscillations, movements, or other haptic feedback generated by the processor 114 based on the dynamic control limits or ranges and/or environment data, and may emit or output the notifications, alerts, vibrations, oscillations, movements, or other haptic feedback at the teleoperator station. Further, the one or more other output devices may receive environment feedback, such as indications of precipitation, temperature, humidity, or other simulated environment feedback, generated by the processor 114 based on the environment data, and may provide, output, or emit the environment feedback to the teleoperator at the teleoperator station to increase environment awareness.

In this manner, the presentation device 116 may provide, present, emit, or output the various visual, audio, and/or haptic notifications, alerts, feedback, simulations, or other indications, such that a teleoperator at the teleoperator station 110 may maintain safe driving behaviors by driving, controlling, or instructing operations of the vehicle 102 within dynamic control limits or ranges, and may also have an increased awareness of an environment around the vehicle 102.

The control interface 118 may comprise a steering wheel, acceleration pedal, brake pedal, transmission selector, and/or various other interface components to generate drive control commands for the vehicle 102. In addition, the control interface 118 may include components, elements, or interfaces to control or instruct various other aspects of the vehicle 102, such as lights, turn indicators, windshield wipers, power windows, power doors, climate control systems, entertainment or infotainment systems, and/or various other systems, devices, or accessories associated with the vehicle 102. The control interface 118 may receive drive control commands provided or input by a teleoperator at the teleoperator station 110, which may then be processed and/or transmitted to the vehicle 102 via the network 105. Further, various visual, audio, and/or haptic notifications, alerts, feedback, simulations, or other indications, may be provided, emitted, or output via various components of the control interface 118, as further described herein.

Although FIG. 1 illustrates an example remote driving system having a particular number, type, configuration, and arrangement of various components, other example embodiments may include various other numbers, types, configurations, and arrangements of the various components. For example, one or more vehicles may be in communication with one or more teleoperator stations, various types of wireless communication networks may be used to facilitate communication between vehicles and teleoperator stations, the vehicle may include various other numbers, types, configurations, arrangements, or combinations of components, the teleoperator station may include various other numbers, types, configurations, arrangements, or combinations of components, and/or various other modifications may be made in other example embodiments of the example remote driving system.

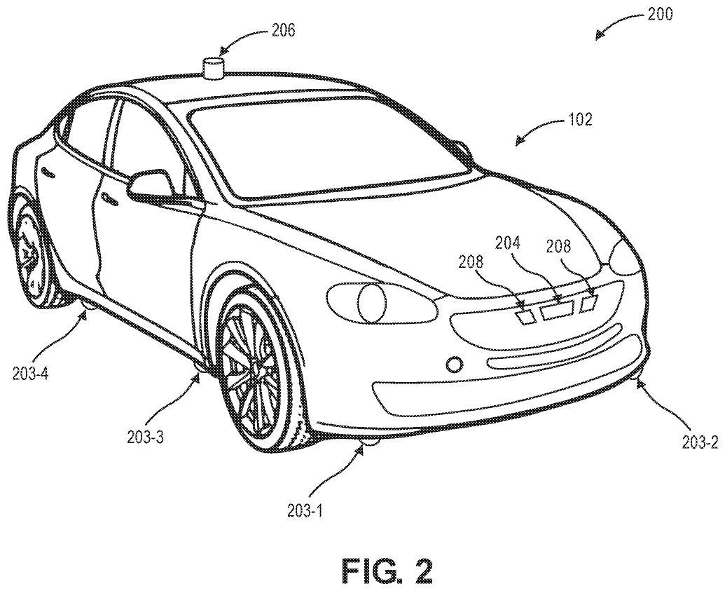

FIG. 2 is a schematic diagram 200 of an example vehicle adapted for remote driving applications, in accordance with implementations of the present disclosure. The example vehicle 102 illustrated in FIG. 2 may include any and all of the features of the vehicle 102 described herein at least with respect to FIG. 1.

For example, the vehicle 102 may include various types of sensors to detect or capture data associated with an environment around the vehicle, including one or more environment sensors 203 for detecting or capturing data associated with the vehicle's environment, one or more imaging devices, cameras, or sensors 204 for capturing imaging data of the vehicle's environment and/or objects in proximity, LIDAR sensors 206, radar sensors 208, or other types of time of flight sensors for detecting or capturing data associated with the vehicle's environment and/or objects in proximity, and/or audio sensors for detecting or capturing audio data associated with the vehicle's environment and/or objects in proximity.

In example embodiments, the environment sensors 203 may comprise weather sensors, temperature sensors, humidity sensors, or other types of environment sensors to detect or measure environment data related to aspects of the environment, including weather, temperature, precipitation, humidity, moisture, driving surface type, surface material properties, tire properties, or other aspects proximate the vehicle 102. In some example embodiments, the environment sensors 203 may comprise various types of sensors, such as imaging sensors, infrared sensors, thermometers, hygrometers, moisture sensors, optical sensors, laser sensors, acoustic sensors, and/or other types of sensors. In addition, one or more environment sensors 203, such as optical, laser, or acoustic sensors, may be positioned or oriented to detect or measure aspects related to roadways, surface conditions, and/or tires, including surface type, material properties, moisture, tire properties, or other aspects. Further, such detected or measured aspects related to roadways, surface conditions, and/or tires may be processed using various machine learning algorithms or techniques to determine associated coefficients of friction based on the environment conditions. In some example embodiments, various environment sensors 203 may be positioned toward a forward movement direction of the vehicle 102, toward a rearward movement direction of the vehicle 102, underneath or pointed toward a ground or surface under the vehicle 102, proximate one or more tires or wheels of the vehicle 102, and/or at various other positions or orientations.

In the example of FIG. 2, the environment sensors 203 may include a plurality of sensors 203-1, 203-2, 203-3, 203-4 distributed around an underside of the vehicle 102, e.g., toward a forward portion of the vehicle 102 and proximate various tires or wheels of the vehicle 102, in order to capture environment data of an environment underneath and along one or more movement directions of the vehicle 102. Although not illustrated in FIG. 2, various additional environment sensors may be positioned at other portions of the vehicle 102 to capture environment data of the environment at other positions relative to the vehicle, e.g., toward a rearward movement direction, toward lateral sides or corners of the vehicle, or any other positions or orientations.

Furthermore, environment data that is captured by the environment sensors 203 may be processed to determine various aspects of the environment proximate the vehicle, including surface conditions and/or friction conditions, such as friction conditions between a surface of a roadway and tires of the vehicle. Based on the determined environment, surface, and/or friction conditions, one or more dynamic control limits or ranges for safe remote operation of the vehicle 102 may be determined.

In example embodiments, the imaging devices or cameras 204 associated with the vehicle 102 may comprise various types of imaging sensors, analog cameras, digital cameras, video cameras, depth sensors, infrared sensors, or other types of imaging sensors. The imaging devices or cameras 204 may be positioned and oriented at various positions on the vehicle 102 in order to capture imaging data of an environment at least partially around the vehicle 102, e.g., towards a forward movement direction, towards a rearward movement direction, and/or toward various other portions of a periphery of the vehicle 102. In addition, the imaging devices or cameras may capture imaging data, such as video data, live video streams, or other types of imaging data, which may be transmitted to the teleoperator station 110 and used to determine environment conditions and dynamic control limits, as well as increase environment awareness, as further described herein.

In the example of FIG. 2, the imaging devices 204 may be positioned toward a forward portion of the vehicle 102 in order to capture imaging data of an environment toward a forward movement direction of the vehicle 102. Although not illustrated in FIG. 2, various additional imaging devices may be positioned at other portions of the vehicle 102 to capture imaging data of the environment toward other directions relative to the vehicle, e.g., toward a rearward movement direction, toward lateral sides or corners of the vehicle, or any other directions.

Furthermore, imaging data that is captured by the imaging devices 204 may be processed to identify objects or aspects of the environment, and also to identify distances or ranges to objects within the imaging data relative to the vehicle 102. For example, the relative distances or ranges to objects within imaging data may be determined based on stereo imaging data or depth data, imaging data captured from multiple positions or orientations, and/or imaging data captured at different times, and distances or ranges to objects along a movement direction of the vehicle 102 may be determined in order to determine dynamic control limits or ranges for safe remote operation of the vehicle 102.

In example embodiments, LIDAR sensors 206, radar sensors 208, and/or other types of time of flight sensors associated with the vehicle 102 may also be positioned and oriented at various positions on the vehicle 102 in order to capture data of an environment at least partially around the vehicle 102, e.g., towards a forward movement direction, towards a rearward movement direction, and/or toward various other portions of a periphery of the vehicle 102. In addition, the various sensors 206, 208 may capture data of various types of objects, which may be transmitted to the teleoperator station 110 and used to determine environment conditions and dynamic control limits, as well as increase environment awareness, as further described herein.

In the example of FIG. 2, the LIDAR sensor 206 may be positioned at an upper portion of the vehicle 102 to capture data of the environment and/or objects in proximity substantially completely around a periphery of the vehicle 102. In addition, the radar sensors 208 may be positioned toward a forward portion of the vehicle 102 in order to capture data of an environment and/or objects in proximity toward a forward movement direction of the vehicle 102. Although not illustrated in FIG. 2, various additional sensors 206, 208 may be positioned at other portions of the vehicle 102 to capture data of the environment and/or objects toward other directions relative to the vehicle, e.g., toward a rearward movement direction, toward lateral sides or corners of the vehicle, or any other directions.

Furthermore, data that is captured by the various sensors 206, 208 may be processed to identify objects or aspects of the environment, and also to identify distances or ranges to objects within the environment relative to the vehicle 102. For example, distances or ranges to objects along a movement direction of the vehicle 102 may be determined in order to determine dynamic control limits or ranges for safe remote operation of the vehicle 102.

In example embodiments, one or more audio sensors or arrays may also be associated with the vehicle 102 and may comprise various types of microphones, microphone arrays, audio transducers, piezoelectric elements, and/or other types of audio sensors. The audio sensors or arrays may be positioned and oriented at various positions on the vehicle 102 in order to detect and capture audio data of an environment at least partially around the vehicle 102, e.g., towards a forward movement direction, towards a rearward movement direction, proximate tires or wheels of the vehicle, proximate a roof or hood of the vehicle, and/or toward various other portions of a periphery of the vehicle 102. In addition, the audio sensors or arrays may capture audio data of aspects of the environment, such as rain, hail, other precipitation, wind, tire or road noise, or other types of sounds or audio data, which may be transmitted to the teleoperator station 110 and used to determine environment conditions and dynamic control limits, as well as increase environment awareness, as further described herein.

Although not illustrated in FIG. 2, various audio sensors or arrays may be positioned at various portions of the vehicle 102 to capture audio data of the environment toward various directions relative to the vehicle, e.g., toward a forward movement direction, toward a rearward movement direction, toward lateral sides or corners of the vehicle, or any other directions.

Furthermore, audio data that is captured by an audio sensor array or microphone array may be processed to identify sounds or aspects of the environment. For example, sounds or aspects of the environment may be identified in order to determine dynamic control limits or ranges for safe remote operation of the vehicle 102, as well as increase environment awareness of a teleoperator at a teleoperator station.

Using data from the various sensors such as environment sensors onboard or associated with the vehicle 102, environment, surface, and/or friction conditions proximate the vehicle 102 may be determined to in order to determine dynamic control limits or ranges for the vehicle. In addition, based on data from various sensors such as imaging, ranging, audio, or vehicle dynamics sensors, various environment, surface, and/or friction conditions proximate the vehicle 102 may be confirmed or verified as part of the determination of dynamic control limits or ranges for the vehicle.

Further, based on data from various sensors such as imaging or ranging sensors, distances or ranges to objects in proximity may be determined in order to determine dynamic control limits or ranges for the vehicle, as well as to instruct, command, and/or maintain safe operation of the vehicle using the dynamic control limits or ranges. Moreover, based on data from various sensors such as vehicle dynamics sensors, current speeds, accelerations, and/or steering angles of the vehicle may be determined in order to determine dynamic control limits or ranges for the vehicle, as well as to instruct, command, and/or maintain safe operation of the vehicle using the dynamic control limits or ranges. Furthermore, based on data from various sensors such as environment, imaging, ranging, audio, or vehicle dynamics sensors, various types of notifications, alerts, or feedback may be provided to a teleoperator at the teleoperator station in order to increase environment awareness of an environment proximate the vehicle.

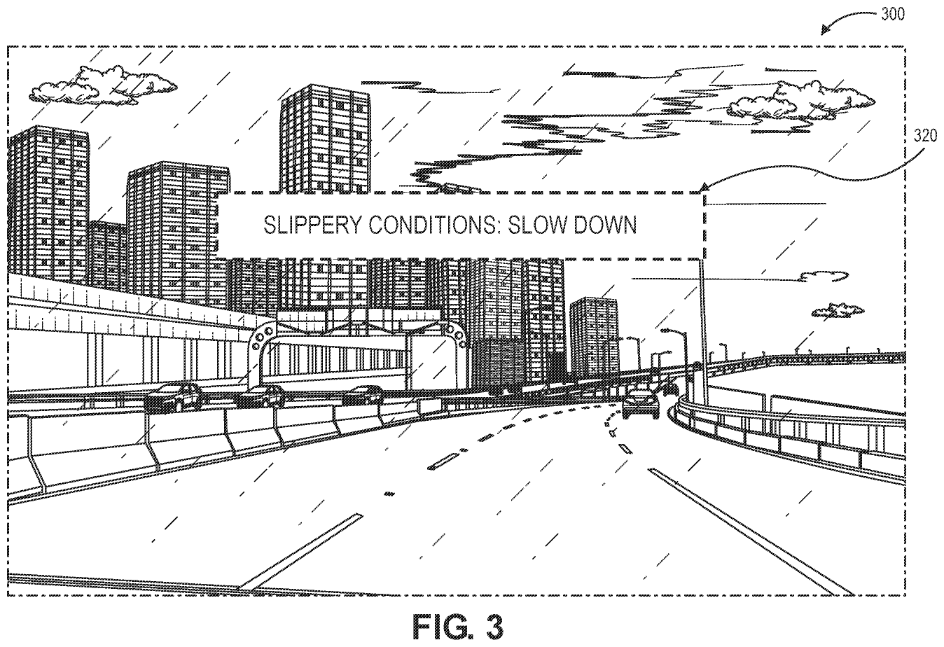

FIG. 3 is a schematic diagram of an example video data 300 including notifications related to dynamic remote operation based on driving conditions, in accordance with implementations of the present disclosure.

As shown in FIG. 3, a vehicle may be traveling along a roadway in an environment. In the example of FIG. 3, there may be precipitation, e.g., rain, in the environment proximate the vehicle, which may affect surface and/or friction conditions of the roadway. In addition, the vehicle may be remotely operated by a teleoperator at a teleoperator station, and the environment proximate the teleoperator station may be very different from the environment proximate the vehicle.

Although precipitation in the environment proximate the vehicle may be visible in the video data 300 that is presented to a teleoperator, the teleoperator may not fully grasp or may underestimate the corresponding changes to surface and/or friction conditions of the roadway on which the vehicle is traveling as a result of the precipitation. Accordingly, as further described herein, in order to ensure safe and reliable remote operation of the vehicle, one or more dynamic control limits for the vehicle may be determined based on the environment conditions, and one or more notifications or alerts 320 may also be presented, emitted, or output to the teleoperator to increase environment awareness.

In example embodiments, one or more environment sensors associated with the vehicle may detect or measure aspects of the environment, e.g., weather, temperature, precipitation, humidity, moisture, driving surface type, surface material properties, or other aspects. For example, the environment sensors may comprise various types of sensors, such as imaging sensors, infrared sensors, thermometers, hygrometers, moisture sensors, optical sensors, laser sensors, acoustic sensors, and/or other types of sensors. In addition, one or more environment sensors, such as optical, laser, or acoustic sensors, may be positioned or oriented to detect or measure aspects related to roadways, surface conditions, and/or tires, including surface type, material properties, moisture, tire properties, or other aspects. Further, such detected or measured aspects related to roadways, surface conditions, and/or tires may be processed using various machine learning algorithms or techniques to determine associated coefficients of friction based on the environment conditions.

Various types of environment conditions that may affect or change surface and/or friction conditions may be detected by the environment sensors. For example, in addition to precipitation such as rain illustrated in FIG. 3, precipitation may also include snow, ice, sleet, hail, and/or other precipitation that may affect surface and/or friction conditions. In addition, temperature, humidity, and/or moisture along roadways may affect surface and/or friction conditions. Further, various types of terrain, such as concrete, asphalt, dirt, mud, gravel, sand, other loose terrain, and/or other types of materials or composition of terrain or roadways may affect surface and/or friction conditions. Moreover, various other materials, such as oil, grease, or various other liquids, may be present on roadways and affect surface and/or friction conditions. Various other permanent or temporary characteristics of roadways, surface conditions, and/or tires may be detected as part of environment conditions and may affect surface and/or friction conditions.

As set forth herein, various types of environment sensors, such as optical, laser, or acoustic sensors, may detect or measure the environment conditions. In addition, one or more machine learning algorithms or techniques may be trained to identify the various permanent or temporary characteristics of environment conditions and to output associated coefficients of friction based on the environment conditions. Further, the machine learning algorithms or techniques may continue to learn and refine the determinations of coefficients of friction as additional data related to environment conditions is provided to and processed by such algorithms.

In additional example embodiments, a plurality of vehicles may be equipped with environment sensors to detect or measure environment conditions. Environment data from multiple vehicles within a particular environment of interest may be received and processed in order to more reliably and accurately determine surface and/or friction conditions within the environment, e.g., at a location proximate a particular vehicle within the environment. Such environment data may be continuously and/or periodically updated in order to generate a virtual map of surface and/or friction conditions for a plurality of locations within an environment, as well as for a plurality of environments.

In other example embodiments, additional data from other sensors associated with the vehicle may also be received and processed to confirm or verify environment conditions as detected by the environment sensors. For example, imaging data from imaging sensors may be processed to determine and/or confirm various environment conditions, such as precipitation, wind, roadway or surface conditions, and/or other aspects of the environment. In addition, audio data from audio sensors may also be processed to determine and/or confirm various environment conditions, such as sounds related to precipitation, wind, roadway or surface conditions based on tire noise, and/or other aspects of the environment. Further, vehicle dynamics or operational data from vehicle dynamics sensors may also be processed to determine and/or confirm various environment conditions, such as operational changes due to precipitation, roadway or surface characteristics or conditions based on tire slip or loss of traction, and/or other aspects of the environment.

In further example embodiments, data from other third party sources may also be received and processed to confirm or verify environment conditions as detected by the environment sensors. For example, weather data from third party sources may be processed to determine and/or confirm various environment conditions, such as weather, temperature, precipitation, humidity, moisture, wind, roadway or surface conditions, and/or other aspects of the environment.

Based on the various data described herein, e.g., at least based on environment conditions detected via the environment sensors, a coefficient of friction in a longitudinal movement direction (e.g., along a longitudinal axis of the vehicle) between the roadway or surface and the tires of the vehicle may be determined. Then, a maximum deceleration (and a corresponding maximum acceleration) in the longitudinal movement direction may be approximately determined based on the following formula (1):

|a_{x,max}|≤μₓ×g (1)

where a_{x,max} is the maximum deceleration in the longitudinal movement direction, μₓ is the coefficient of friction in the longitudinal movement direction between the surface of the roadway and the tires determined based on data from the environment sensors, and g is acceleration due to gravity.

In some example embodiments, a maximum speed in the longitudinal movement direction may be determined as a dynamic control limit for remote operation of the vehicle based on the maximum deceleration in the longitudinal movement direction. For example, based on data from one or more imaging, ranging, or other sensors, a distance or range to an obstacle, another vehicle, or object along the longitudinal movement direction of the vehicle may be determined. Then, a maximum speed in the longitudinal movement direction may be approximately determined based on the following formula (2):

v_{x,max}=\sqrt{−2×a_{x,max}×S} (2)

where v_{x,max} is the maximum speed in the longitudinal movement direction, a_{x,max} is the maximum deceleration in the longitudinal movement direction determined based on formula (1), and s is the distance or range to an object or another vehicle along the longitudinal movement direction of the vehicle based on data from the imaging or ranging sensors.

Then, remote operation of the vehicle may be controlled or limited in accordance with the maximum speed in the longitudinal movement direction that has been determined based on environment, surface, and/or friction conditions in the environment proximate the vehicle, thereby ensuring safe remote operation of the vehicle.

In some example embodiments, driving commands provided by the teleoperator may be actively limited or controlled by the maximum speed determined based on the environment conditions. As a result, if a teleoperator inputs commands to increase a vehicle speed beyond the maximum speed, the vehicle may not be allowed to travel at speeds greater than the maximum speed. In addition, one or more notification or alerts may be presented, emitted, or output to the teleoperator at the teleoperator station, e.g., via a presentation device, to notify or inform the teleoperator of any actively imposed limits or controls.

In other example embodiments, driving commands provided by the teleoperator may not be actively limited or controlled by the maximum speed determined based on the environment conditions. Instead, one or more notifications or alerts 320 may be presented, emitted, or output to the teleoperator at the teleoperator station, e.g., via a presentation device. For example, if the vehicle speed is greater than the maximum speed determined based on environment conditions, a notification 320 such as that illustrated in the example of FIG. 3 may be presented to alert or encourage the teleoperator to reduce speed and thereby ensure safe driving behaviors.

Further, in response to changes to the detected environment conditions, the determined friction conditions may also change, resulting in a change to the maximum deceleration. As a result, the determined maximum speed may also dynamically change based on the changes to environment conditions to ensure safe remote operation of the vehicle. In addition, changes to the distance or range to an object or another vehicle along a movement direction of the vehicle may also dynamically change the determined maximum speed in order to ensure safe remote operation of the vehicle.

In other example embodiments, a minimum safe stopping distance may be determined as a dynamic control limit for remote operation of the vehicle based on the maximum deceleration in the longitudinal movement direction. For example, based on data from one or more vehicle dynamics or other sensors, a current speed of the vehicle along the longitudinal movement direction may be determined. Then, a minimum stopping distance may be approximately determined based on the following formula (3):

$$\\ \begin{matrix}{s}_{min} = \frac{- {v}_{x}^{2}}{( 2 \times {a}_{x , max} )} & ( 3 )\end{matrix}$$

where sₘᵢₙ is the minimum stopping distance, vₓ is the current speed of the vehicle in the longitudinal movement direction based on data from vehicle dynamics sensors, and a_{x,max} is the maximum deceleration in the longitudinal movement direction determined based on formula (1).

Then, remote operation of the vehicle may be controlled or limited in accordance with the minimum stopping distance that has been determined based on environment, surface, and/or friction conditions in the environment proximate the vehicle, thereby ensuring safe remote operation of the vehicle.

In some example embodiments, driving commands provided by the teleoperator may be actively limited or controlled by the minimum stopping distance determined based on the environment conditions. As a result, if a teleoperator inputs commands to decrease a vehicle distance to an object below the minimum stopping distance, the vehicle may not be allowed to travel at such close distances to an object. In addition, one or more notification or alerts may be presented, emitted, or output to the teleoperator at the teleoperator station, e.g., via a presentation device, to notify or inform the teleoperator of any actively imposed limits or controls.

In other example embodiments, driving commands provided by the teleoperator may not be actively limited or controlled by the minimum stopping distance determined based on the environment conditions. Instead, one or more notifications or alerts may be presented, emitted, or output to the teleoperator at the teleoperator station, e.g., via a presentation device. For example, if the distance or gap between the vehicle and an object is less than the minimum stopping distance determined based on environment conditions, a notification may be presented to alert or encourage the teleoperator to increase the distance or gap and thereby ensure safe driving behaviors.

Further, in response to changes to the detected environment conditions, the determined friction conditions may also change, resulting in a change to the maximum deceleration. As a result, the determined minimum stopping distance may also dynamically change based on the changes to environment conditions to ensure safe remote operation of the vehicle. In addition, changes to the current speed of the vehicle may also dynamically change the determined minimum stopping distance in order to ensure safe remote operation of the vehicle.

In further example embodiments, the maximum deceleration (and acceleration) in the longitudinal movement direction may itself be utilized as a dynamic control limit for remote operation of the vehicle. For example, based on data from one or more vehicle dynamics or other sensors, a current acceleration or deceleration command of the vehicle may be determined.

Then, remote operation of the vehicle may be controlled or limited in accordance with the maximum deceleration (and acceleration) that has been determined based on environment, surface, and/or friction conditions in the environment proximate the vehicle, thereby ensuring safe remote operation of the vehicle. Further, in response to changes to the detected environment conditions, the determined friction conditions may also change, resulting in a change to the maximum deceleration (and acceleration) in the longitudinal movement direction.

In additional example embodiments, the determination of the maximum deceleration (and acceleration) may be affected, adjusted, or modified based on other data received from one or more sensors, such that the maximum deceleration may be sensitive to changing scenarios or situations. For example, while the vehicle is traveling in a forward movement direction, if a following vehicle is detected at a first distance behind the vehicle, the maximum deceleration may be adjusted based on the presence of the following vehicle and/or the first distance between the following vehicle and the vehicle. In addition, if a forward vehicle is detected at a first distance in front of the vehicle, and a following vehicle is also detected at a second distance behind the vehicle, the maximum deceleration may be adjusted based on the presence of the forward vehicle and the following vehicle, the first distance between the forward vehicle and the vehicle, and/or the second distance between the following vehicle and the vehicle. Various other scenarios or situations relative to the vehicle and/or objects in proximity may affect or modify the determination of the maximum deceleration (and acceleration).

In further example embodiments, the determination of the maximum deceleration (and acceleration) may be affected, adjusted, or modified based on other data received from one or more sensors related to surface characteristics of a roadway. For example, if one or more sensors, e.g., inertial measurement units, accelerometers, gyroscopes, or others, detect that the vehicle is traveling uphill on an inclined roadway, the maximum deceleration may be adjusted based on the gravitational forces acting on the vehicle tending to slow the movement of the vehicle. In addition, if one or more sensors, e.g., inertial measurement units, accelerometers, gyroscopes, or others, detect that the vehicle is traveling downhill on a declined roadway, the maximum deceleration may be adjusted based on the gravitational forces acting on the vehicle tending to speed up the movement of the vehicle. Various other surface characteristics of a roadway may affect or modify the determination of the maximum deceleration (and acceleration).

For example, based on the various data described herein, e.g., at least based on environment conditions detected via the environment sensors, a coefficient of friction in a longitudinal movement direction (e.g., along a longitudinal axis of the vehicle) between the roadway or surface and the tires of the vehicle may be determined. Then, a maximum deceleration (and a corresponding maximum acceleration) in the longitudinal movement direction may be approximately determined based on the following formula (1.1), which also takes into account angle of inclination of a roadway surface relative to horizontal:

$$\\ \begin{matrix}{μ}_{x} \times ( g + ( \frac{1}{m} ) sin ( θ ) ) < \vert {a}_{x} \vert < {μ}_{x} \times ( g - ( \frac{1}{m} ) sin ( θ ) ) & ( 1.1 )\end{matrix}$$

where aₓ is the maximum acceleration in the longitudinal movement direction, μₓ is the coefficient of friction in the longitudinal movement direction between the surface of the roadway and the tires determined based on data from the environment sensors, m is the vehicle mass, θ is the angle of inclination of the roadway surface, and g is acceleration due to gravity.

In the formula (1.1), the left inequality may define or describe a maximum deceleration for a vehicle that is slowing or braking while traveling uphill on a roadway surface having the angle of inclination. In addition, the right inequality may define or describe a maximum acceleration for a vehicle that is speeding up or accelerating while traveling uphill on a roadway surface having the angle of inclination. As a result, the maximum acceleration for a vehicle traveling uphill on a roadway surface having an angle of inclination may have lower and upper limits associated with braking and accelerating, respectively, along the roadway surface. In similar or corresponding manner, a maximum deceleration (and acceleration) for a vehicle traveling downhill on a roadway surface having an angle of inclination may also have lower and upper limits associated with braking and accelerating along the roadway surface.

In some example embodiments, driving commands provided by the teleoperator may be actively limited or controlled by the maximum deceleration (and acceleration) determined based on the environment conditions. As a result, if a teleoperator inputs commands to decelerate or accelerate greater than the maximum deceleration (or acceleration), the vehicle may not be allowed to travel at such deceleration or acceleration. In addition, one or more notifications or alerts may be presented, emitted, or output to the teleoperator at the teleoperator station, e.g., via a presentation device, to notify or inform the teleoperator of any actively imposed limits or controls.

In other example embodiments, driving commands provided by the teleoperator may not be actively limited or controlled by the maximum deceleration (and acceleration) determined based on the environment conditions. Instead, one or more notifications or alerts may be presented, emitted, or output to the teleoperator at the teleoperator station, e.g., via a presentation device. For example, if the deceleration or acceleration is greater than the maximum deceleration (or acceleration) determined based on environment conditions, a notification may be presented to alert or encourage the teleoperator to reduce the deceleration or acceleration and thereby ensure safe driving behaviors.

In further example embodiments, a maximum steering angle or rate of change of steering angle may be determined as a dynamic control limit for remote operation of the vehicle based on the maximum deceleration in a lateral movement direction (e.g., along a lateral or transverse axis of the vehicle). Based on the various data described herein, e.g., at least based on environment conditions detected via the environment sensors, a coefficient of friction in a lateral movement direction between the roadway or surface and the tires of the vehicle may be determined, which may further take into account a lateral or transverse axis of the steered tires relative to the lateral or transverse axis of the vehicle. Then, a maximum lateral acceleration may be approximately determined based on the following formula (4), which is similar to formula (1) herein:

|a_{y,max}|≤μ_{y}×g (4)

where a_{y,max} is the maximum lateral acceleration, μ_{y} is the coefficient of friction in the lateral movement direction between the roadway and the tires determined based on data from the environment sensors, and g is acceleration due to gravity.

In addition, based on vehicle data and data from one or more vehicle dynamics or other sensors, vehicle lateral acceleration may be approximately determined based on the following formula (5):

a_{y}=r×vₓ (5)

where a_{y} is the vehicle lateral acceleration, r is the vehicle yaw rate in steady state conditions based on vehicle configuration data, and vₓ is the vehicle speed in the longitudinal movement direction determined based on data from vehicle dynamics sensors.

Further, the vehicle yaw rate, represented as r, can be approximated based on the following formula (6):

$$\\ \begin{matrix}r = \frac{{v}_{x}}{l} \times δ & ( 6 )\end{matrix}$$

where vₓ is the vehicle speed in the longitudinal movement direction determined based on data from vehicle dynamics sensors, l is the vehicle wheel-base associated with the vehicle based on vehicle configuration data, and δ is the road-wheel steering angle determined based on data from vehicle dynamics sensors. In addition, the road-wheel steering angle, represented as δ, can be approximated based on the following formula (7):

δ=iₛ×δ_{H} (7)

where δ_{H} is the hand-wheel steering angle based on teleoperator station configuration data, and is the steering ratio between the road-wheel steering angle and the hand-wheel steering angle associated with the vehicle based on vehicle configuration data and teleoperator station configuration data.

Then, by combining formulas (4)-(7), a maximum hand-wheel steering angle, represented as δ_{H,max}, based on the current vehicle speed in the longitudinal movement direction represented as vₓ, may be approximately determined based on the following formula (8):

$$\\ \begin{matrix}{δ}_{H , max} = \frac{l \times g}{{i}_{s} \times {v}_{x}^{2}} \times {μ}_{y} & ( 8 )\end{matrix}$$

According to formula (8), the determination of a maximum hand-wheel steering angle based on current vehicle speed in the longitudinal movement direction may prioritize dynamic control of longitudinal movement, speed, and/or acceleration of the vehicle, e.g., along a longitudinal axis of the vehicle, over control of lateral movement, speed, and/or acceleration of the vehicle. Thus, the maximum hand-wheel steering angle may be limited in order to maintain dynamic control of the vehicle in a longitudinal movement direction.

Alternatively or in addition, by combining formulas (4)-(7), a maximum vehicle speed in the longitudinal movement direction, represented as v_{x,max}, based on the hand-wheel steering angle represented as δ_{H}, may be approximately determined based on the following formula (9):

$$\\ \begin{matrix}{v}_{x , max} = \sqrt{\frac{l \times g}{{i}_{s} \times {δ}_{H}} \times {μ}_{y}} & ( 9 )\end{matrix}$$

According to formula (9), the determination of a maximum vehicle speed in the longitudinal movement direction based on current hand-wheel steering angle may prioritize dynamic control of lateral movement, speed, and/or acceleration of the vehicle, e.g., along a lateral or transverse axis of the vehicle, over control of longitudinal movement, speed, and/or acceleration of the vehicle. Thus, the maximum vehicle speed in the longitudinal movement direction may be limited in order to maintain dynamic control of the vehicle in a lateral movement direction according to the current hand-wheel steering angle.

Based on the approximate determination of maximum hand-wheel steering angle based on current vehicle speed and friction conditions, and/or based on the approximate determination of maximum vehicle speed based on current hand-wheel steering angle and friction conditions, remote operation of the vehicle may be controlled or limited in accordance with the maximum hand-wheel steering angle or the maximum vehicle speed that has been determined based on environment, surface, and/or friction conditions in the environment proximate the vehicle, thereby ensuring safe remote operation of the vehicle.

In some example embodiments, driving commands provided by the teleoperator may be actively limited or controlled by the maximum hand-wheel steering angle or the maximum vehicle speed determined based on the environment conditions. As a result, if a teleoperator inputs commands to turn at a steering angle greater than the maximum hand-wheel steering angle while traveling at a specified speed, the vehicle may not be allowed to turn at such a steering angle while traveling at the specified speed. In addition, if a teleoperator inputs commands to increase a vehicle speed beyond the maximum speed while turning at a specified steering angle, the vehicle may not be allowed to travel at speeds greater than the maximum speed while turning at the specified steering angle. Further, one or more notifications or alerts may be presented, emitted, or output to the teleoperator at the teleoperator station, e.g., via a presentation device, to notify or inform the teleoperator of any actively imposed limits or controls.

In other example embodiments, driving commands provided by the teleoperator may not be actively limited or controlled by the maximum hand-wheel steering angle or the maximum vehicle speed determined based on the environment conditions. Instead, one or more notifications or alerts may be presented, emitted, or output to the teleoperator at the teleoperator station, e.g., via a presentation device. For example, if the steering angle is greater than the maximum hand-wheel steering angle determined based on environment conditions while traveling at a specified speed, a notification may be presented to alert or encourage the teleoperator to reduce the steering angle and thereby ensure safe driving behaviors. In addition, if the vehicle speed is greater than the maximum speed determined based on environment conditions while turning at a specified steering angle, a notification 320 such as that illustrated in the example of FIG. 3 may be presented to alert or encourage the teleoperator to reduce speed and thereby ensure safe driving behaviors.

Further, in response to changes to the detected environment conditions, the determined friction conditions may also change, resulting in a change to the maximum lateral acceleration. As a result, the determined maximum hand-wheel steering angle or the maximum vehicle speed may also dynamically change based on the changes to environment conditions to ensure safe remote operation of the vehicle. In addition, changes to the current speed of the vehicle may also dynamically change the determined maximum hand-wheel steering angle in order to ensure safe remote operation of the vehicle. Similarly, changes to the current steering angle of the vehicle may also dynamically change the determined maximum vehicle speed in order to ensure safe remote operation of the vehicle.

In still further example embodiments, various combinations of maximum deceleration (or acceleration), maximum speed, minimum stopping distance, maximum steering angle, and/or other vehicle operational characteristics may be determined as dynamic control limits based on environment conditions, in order to ensure safe remote operation of the vehicle by a teleoperator at a teleoperator station. As described herein, the detected aspects of environment conditions may affect surface and/or friction conditions between roadways, surfaces, and tires of a vehicle that is remotely operated. Then, based on the determined surface and/or friction conditions, various dynamic control limits or ranges may be determined for safe remote operation by teleoperators.

Although FIG. 3 illustrates only visual notifications or alerts related to dynamic control limits, in additional example embodiments, various other types of notifications or alerts may be presented to a teleoperator via a presentation device, e.g., a screen, monitor, or display, at the teleoperator station. For example, the visual notifications may also include other types of visual cues or indicators, such as flashing, highlighting, changing colors, changing sizes, changing positions, or various other changes to data or information presented to the teleoperator. In one example, for dynamic control limits related to maximum speed, the presentation of a speedometer may be changed or modified as the current speed approaches or exceeds the maximum speed, such as by changing colors, flashing, changing size, changing a display position, and/or various other changes.

In addition, various audio notifications or alerts may also be presented or emitted to a teleoperator via a presentation device, e.g., speakers, at the teleoperator station. For example, the audio notifications may include audio cues, indicators, or messages, such as beeps, tones, alarms, warnings, or various other data or information emitted or output to the teleoperator. In some examples, for various dynamic control limits, various levels or gradations of messages or warnings may be emitted or output as one or more vehicle operational characteristics approach and/or exceed associated dynamic control limits.

Furthermore, various haptic notifications or alerts may also be presented or emitted to a teleoperator via a presentation device, e.g., pedals, steering wheel, seat, or other portions of the control interface, at the teleoperator station. For example, the haptic notifications may include movement, buzzing, vibration, oscillation, shaking, changes to resistance, or various other data or information emitted or output to the teleoperator. In some examples, for various dynamic control limits, various levels or gradations of movement, vibration, or resistance may be emitted or output as one or more vehicle operational characteristics approach and/or exceed associated dynamic control limits.

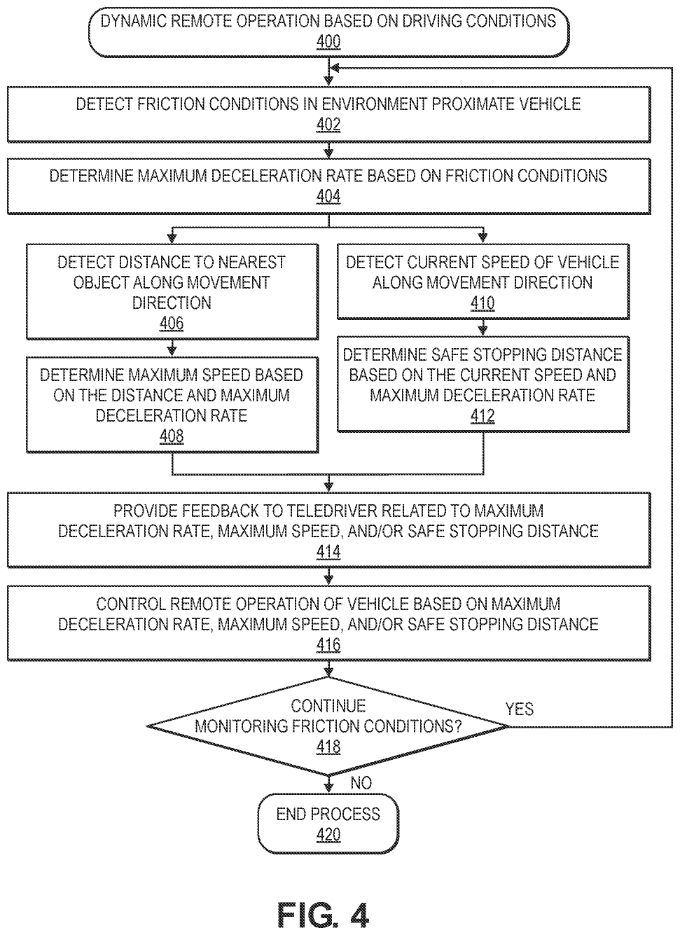

FIG. 4 is a flow diagram illustrating an example dynamic remote operation based on driving conditions process 400, in accordance with implementations of the present disclosure.

The process 400 may begin by detecting friction conditions in an environment proximate a vehicle, as at 402. For example, one or more environment sensors associated with a vehicle may detect environment conditions within the environment, including surface and/or friction conditions associated with the roadway, driving surface, and/or tires of the vehicle. The environment sensors may comprise various types of sensors, such as optical, laser, acoustic, or other types of sensors. In addition, the data detected or measured by the environment sensors may be processed using various machine learning algorithms or techniques to determine coefficients of friction of roadways, surfaces, and/or tires within the environment. Further, a control system may command or instruct detection, by environment sensors, of friction conditions in an environment proximate a vehicle.

The process 400 may continue by determining a maximum deceleration based on the friction conditions, as at 404. For example, based on a determined coefficient of friction of a roadway, surface, and/or tires associated with a vehicle within an environment, a maximum deceleration for the vehicle may be determined to maintain traction and ensure safe remote operation based on the environment conditions. Generally, the maximum deceleration may be similar or the same as the maximum acceleration. In addition, the maximum deceleration may be approximately determined using the formula (1) set forth herein. Further, a control system may determine the maximum deceleration based on the friction conditions.

The process 400 may proceed by detecting a distance to a nearest object along a movement direction, as at 406, and also determining a maximum speed based on the distance and the maximum deceleration, as at 408. For example, a distance or range to an object along a movement direction may be detected by one or more imaging or ranging sensors, such as cameras, stereo imaging devices, depth sensors, radar sensors, LIDAR sensors, or other types of imaging or time of flight sensors. Based on the detected distance or range to a nearest object, a maximum speed for the vehicle may be determined in accordance with the maximum deceleration. In addition, the maximum speed may be approximately determined using the formula (2) set forth herein. Further, a control system may detect the distance or range to a nearest object, and determine a maximum speed based on the distance and the maximum deceleration.

The process 400 may also proceed by detecting a current speed of the vehicle along a movement direction, as at 410, and also determining a safe stopping distance based on the current speed and the maximum deceleration, as at 412. For example, a current vehicle speed along a movement direction may be determined based on data from vehicle dynamics sensors, such as speedometers, encoders, or other types of vehicle dynamics sensors. Based on the detected current speed, a minimum or safe stopping distance for the vehicle may be determined in accordance with the maximum deceleration. In addition, the minimum or safe stopping distance may be approximately determined using the formula (3) set forth herein. Further, a control system may detect the current vehicle speed, and determine a minimum stopping distance based on the current speed and the maximum deceleration.

The process 400 may then continue to provide feedback to a teledriver related to the maximum deceleration, the maximum speed, and/or the safe stopping distance, as at 414. For example, various notifications or alerts may be presented to the teledriver or teleoperator via a presentation device at the teleoperator station. The various notifications may comprise visual, audio, and/or haptic notifications or alerts related to the dynamic control limits or ranges for maximum deceleration, maximum speed, and/or minimum safe stopping distance. As set forth herein, the dynamic control limits or ranges may also include maximum acceleration or deceleration, and/or maximum steering angles. In addition, the dynamic control limits or ranges may also include various combinations of maximum acceleration or deceleration, maximum speed, minimum stopping distance, maximum steering angle, and/or other operational aspects. Moreover, the various notifications may comprise various levels or gradations of alerts, indicators, or messages as one or more vehicle operational characteristics approach and/or exceed the dynamic control limits. Further, a control system may cause presentation, output, or emission of various notifications to a teleoperator based on applicable dynamic control limits or ranges.

The process 400 may also proceed to control remote operation of the vehicle based on the maximum deceleration, the maximum speed, and/or the safe stopping distance, as at 416. For example, in addition or alternatively to providing feedback or notifications to a teleoperator, as at 414, various limits related to vehicle operational aspects may be implemented or effected at or by the vehicle in accordance with the dynamic control limits or ranges. In some examples, acceleration or deceleration may be limited to remain below the maximum acceleration or deceleration, vehicle speed may be limited to remain below the maximum speed, vehicle movement may be controlled to maintain the minimum stopping distance, turning or steering of the vehicle may be limited to remain within the maximum steering wheel angle, and/or various other dynamic control limits or ranges may be automatically and/or substantially autonomously implemented or enforced by the vehicle. Further, a control system may command or instruct remote operation of the vehicle based on applicable dynamic control limits or ranges.

The process 400 may then continue with determining whether to continue monitoring friction conditions, as at 418. For example, environment conditions, and corresponding surface and/or friction conditions, may change during remote operation of the vehicle, e.g., due to changes in the weather, temperature, or precipitation, changes in roadway characteristics, changes to tire properties, and/or various other changes. In addition, based on changes to environment conditions over time, applicable control limits or ranges for the vehicle may also dynamically change over time. Thus, environment conditions may be periodically and/or continuously monitored during remote operation of a vehicle by a teleoperator. Further, a control system may determine whether to continue monitoring environment conditions for a vehicle.

If it is determined that monitoring environment, surface, and/or friction conditions is to continue, the process 400 may return to step 402 to continue processing the data related to environment conditions and determining applicable dynamic control limits or ranges. If, however, it is determined that monitoring environment, surface, and/or friction conditions is not to continue, the process 400 may then end, as at 420.

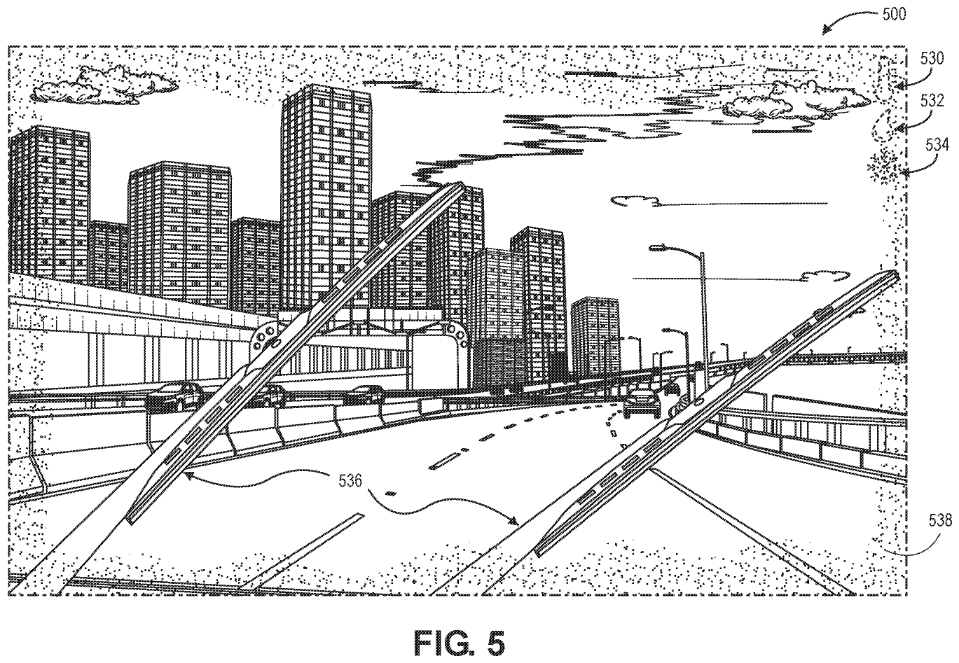

FIG. 5 is a schematic diagram of an example video data 500 including feedback to increase environment awareness based on driving conditions, in accordance with implementations of the present disclosure.

In example embodiments, in addition to commanding or implementing various vehicle operational changes, limits, or controls, and/or presenting or emitting various notifications based on the determined dynamic control limits or ranges that are further based on environment, surface, and/or friction conditions, various feedback may also be provided, presented, output, or emitted to a teleoperator at a teleoperator station in order to increase awareness of the environment proximate the vehicle. The various feedback may comprise visual, audio, haptic, or other types of feedback to increase environment awareness by the teleoperator.

For example, because a teleoperator station from which a teleoperator may remotely operate a vehicle may be in a different location, city, region, country, time zone, or other geographic area from a vehicle that is being remotely operated by the teleoperator, the teleoperator may not have a full understanding or may underestimate the environment conditions proximate the vehicle, as well as corresponding surface and/or friction conditions within the environment. Thus, various types of feedback may be provided to a teleoperator at a teleoperator station in order to increase environment awareness.

In some example embodiments, various visual feedback may be provided or presented to a teleoperator via a presentation device, e.g., a display, screen, or monitor, at the teleoperator station. For example, one or more visual cues, icons, or indicators 530, 532, 534 may be presented via a display, screen, or monitor to indicate current environment conditions. The icon 530 may provide an indication of a current temperature in the environment, the icon 532 may provide an indication of current rainfall or moisture in the environment, and/or the icon 534 may provide an indication of current snow, ice, sleet, and/or hail in the environment. Various other types of visual cues, icons, indicators, messages, or other data or information may be presented to the teleoperator.

In additional example embodiments, various visual feedback may also comprise visual simulations of environment conditions that are presented to a teleoperator via a presentation device, e.g., a display, screen, or monitor, at the teleoperator station. In some examples, imaging devices that capture and provide imaging data, e.g., video data, to be presented to a teleoperator may be positioned or located outside of a vehicle cabin, such as toward a forward portion of the vehicle, on a roof of the vehicle, or at other positions proximate an exterior of the vehicle. As a result, the operation of windshield wipers, defrosters, defoggers, other climate control aspects, and/or other similar systems or accessories may not be captured by the imaging devices, which may be relatively clear and unobtrusive indicators of current environment conditions. Thus, based on the environment conditions, various operations of windshield wipers, defrosters, defoggers, other climate control aspects, and/or other similar systems or accessories may be simulated, overlaid, and presented with the imaging data captured by the imaging devices. As shown in FIG. 5, windshield wipers 536 may be simulated and presented with the imaging data to indicate current precipitation in the environment, and/or operations of defrosters and/or defoggers 538 may also be simulated as partially occluded portions around a periphery of the display with the imaging data to indicate current temperature, humidity, and/or moisture in the environment. Various operations of other systems or accessories related to environment conditions may also be simulated and presented in an unobtrusive manner as visual indicators of current environment conditions.

In other example embodiments, various audio feedback may also be provided or presented to a teleoperator via a presentation device, e.g., speakers, at the teleoperator station. For example, one or more audio cues, indicators, or messages may be presented via one or more speakers to indicate current environment conditions. The audio cues may provide an indication of a current temperature, current precipitation, current road conditions, traction characteristics, or other aspects in the environment. Various other types of audio cues, indicators, messages, or other data or information may be presented to the teleoperator.

In additional example embodiments, various audio feedback may also comprise audio simulations of environment conditions that are presented to a teleoperator via a presentation device, e.g., speakers, at the teleoperator station. In some examples, noise or sounds related to precipitation, such as raindrops, sleet, hail, or others, may be simulated and presented or emitted to a teleoperator. In addition, noise or sounds related to wind or other environment conditions may also be simulated and presented or emitted to a teleoperator. Further, noise or sounds related to road surface characteristics, such as tire noise when traveling on snow or ice, tire noise when traveling on dirt or gravel, and/or other types of noise or sounds related to roadways, surfaces, and/or tires, may be simulated and presented or emitted to a teleoperator. Various other types of noise or sounds related to environment conditions may also be simulated and presented in an unobtrusive manner as audio indicators of current environment conditions.

In further example embodiments, various haptic feedback may also be provided or presented to a teleoperator via a presentation device, e.g., steering wheel, pedals, seat, other portions of a control interface, and/or other output devices, at the teleoperator station. For example, one or more haptic cues, indicators, or alerts may be presented via one or more portions of a control interface to indicate current environment conditions. The haptic cues may provide an indication of a current precipitation, current road conditions, traction characteristics, or other aspects in the environment. In some example, the haptic feedback may emulate or simulate operations of various driver assistance technologies, such as braking assistance systems, lane keeping assistance systems, and/or other similar driver assistance systems or accessories, through motion, vibration, shaking, resistance, or other feedback provided via a steering wheel, pedals, or other portions of the control interface. Various other types of haptic cues, indicators, alerts, or other data or information may be presented to the teleoperator.

In additional example embodiments, various haptic feedback may also comprise haptic simulations of environment conditions that are presented to a teleoperator via a presentation device, e.g., steering wheel, pedals, seat, other portions of a control interface, and/or other output devices, at the teleoperator station. In some examples, aspects of the environment may be emulated or simulated proximate the teleoperator station by various types of output devices, such as climate control systems, water or snow emission or sprinkling systems, or other sensory emission systems. For example, a temperature at the teleoperator station may be adjusted or modified based on a current temperature in the environment proximate the vehicle, e.g., by raising or lowering the temperature. In addition, humidity or moisture at the teleoperator station may also be adjusted or modified based on a current humidity or moisture in the environment proximate the vehicle, e.g., by modifying air quality and/or composition. Further, precipitation such as rain or snow may be simulated or generated at the teleoperator station, and emitted or output at the teleoperator station, e.g., by sprinkling water drops or snowflakes. Moreover, portions of the control interface, such as the steering wheel, pedals, and/or seat, may move, vibrate, or shake based on environment conditions, such as road conditions, slippery or slick terrain, loose or uneven terrain, traction characteristics, and/or various other aspects related to roadways, surfaces, and/or tires. Various other types of feedback related to environment conditions may also be simulated and presented or emitted in an unobtrusive manner as haptic indicators of current environment conditions.

As described herein, the various types of visual, audio, and/or haptic feedback may increase environment awareness by teleoperators at teleoperator stations that are remote and/or distant from the vehicles that are being remotely operated. By increasing environment awareness, the teleoperators may be able to more safely and reliably operate remotely-located vehicles within their respective environments.

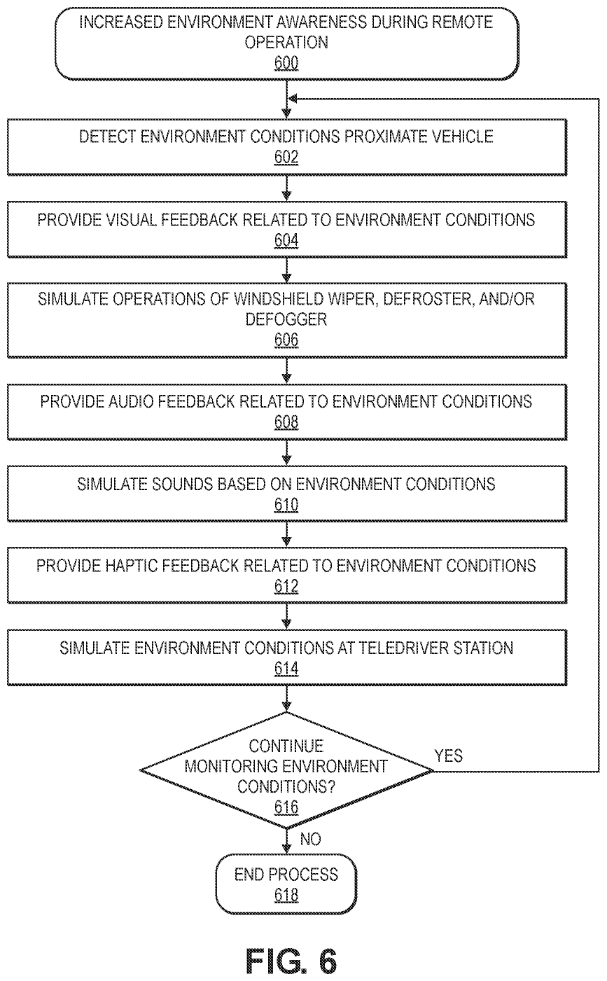

FIG. 6 is a flow diagram illustrating an example increased environment awareness during remote operation process 600, in accordance with implementations of the present disclosure.

The process 600 may begin by detecting environment conditions proximate a vehicle, as at 602. For example, one or more environment sensors associated with a vehicle may detect environment conditions within the environment, including weather, temperature, precipitation, wind direction or speed, humidity, moisture, driving surface type, surface material properties, tire or traction characteristics, or other aspects associated with the roadway, driving surface, and/or tires of the vehicle. The environment sensors may comprise various types of sensors, such as imaging sensors, infrared sensors, thermometers, hygrometers, moisture sensors, optical sensors, laser sensors, acoustic sensors, and/or other types of sensors. In addition, the data detected or measured by the environment sensors may be processed using various processing algorithms and/or machine learning algorithms or techniques to determine aspects of the environment, such as temperature, precipitation, surface conditions, tire characteristics, and others, as well as coefficients of friction of roadways, surfaces, and/or tires within the environment. Further, a control system may command or instruct detection, by environment sensors, of environment conditions in an environment proximate a vehicle.

The process 600 may continue by providing visual feedback related to environment conditions, as at 604. For example, various visual cues, icons, or indicators may be presented via a presentation device at the teleoperator station to indicate aspects of current environment conditions, such as temperature icons or indicators, rain or snow icons or indicators, or other types of visual cues or indicators. The various visual feedback may be provided or presented via a display, screen, or monitor associated with the teleoperator station. Further, a control system may command or instruct presentation of visual feedback related to environment conditions.

The process 600 may proceed by simulating operations of windshield wipers, defroster, and/or defogger, as at 606. For example, various visual feedback related to current environment conditions may also be simulated and presented with imaging data of the environment for a teleoperator. The simulated visual feedback may be indicative of aspects of environment conditions, such as temperature, precipitation, humidity, wind, and/or other aspects. Further, a control system may command or instruct presentation of various simulated visual feedback related to environment conditions.

The process 600 may continue to provide audio feedback related to environment conditions, as at 608. For example, various audio cues, messages, or indicators may be presented via a presentation device at the teleoperator station to indicate aspects of current environment conditions, such as indicators related to temperature, precipitation, road conditions, or other aspects. The various audio feedback may be provided or presented via speakers associated with the teleoperator station. Further, a control system may command or instruct presentation of audio feedback related to environment conditions.

The process 600 may proceed to simulate sounds based on environment conditions, as at 610. For example, various audio feedback related to current environment conditions may also be simulated and presented or emitted to a teleoperator. The simulated audio feedback may be indicative of aspects of environment conditions, such as raindrops, sleet, hail, wind, road conditions, tire noise, and/or other aspects. Further, a control system may command or instruct presentation of various simulated audio feedback related to environment conditions.

The process 600 may continue with providing haptic feedback related to environment conditions, as at 612. For example, various haptic cues, indicators, or alerts may be presented via a presentation device at the teleoperator station to indicate aspects of current environment conditions, such as indicators related to precipitation, road conditions, or other aspects. The various haptic feedback may be provided or presented via portions of a control interface and/or other output devices associated with the teleoperator station. Further, a control system may command or instruct presentation of haptic feedback related to environment conditions.

The process 600 may proceed with simulating environment conditions at the teledriver station, as at 614. For example, various haptic feedback related to current environment conditions may also be simulated and presented, emitted, or output to a teleoperator at a teledriver or teleoperator station. The simulated haptic feedback may be indicative of aspects of environment conditions, such as temperature, humidity, precipitation, road conditions, traction characteristics, and/or other aspects. Further, a control system may command or instruct presentation of various simulated haptic feedback related to environment conditions.

The process 600 may then continue by determining whether to continue monitoring environment conditions, as at 616. For example, environment conditions, and corresponding surface and/or friction conditions, may change during remote operation of the vehicle, e.g., due to changes in the weather, temperature, or precipitation, changes in roadway characteristics, changes to tire properties, and/or various other changes. In addition, based on changes to environment conditions over time, various feedback or simulations to be provided, presented, or emitted to increase environment awareness of a teleoperator may also dynamically change over time. Thus, environment conditions may be periodically and/or continuously monitored during remote operation of a vehicle by a teleoperator. Further, a control system may determine whether to continue monitoring environment conditions for a vehicle.

If it is determined that monitoring environment conditions is to continue, the process 600 may return to step 602 to continue processing the data related to environment conditions and determining various types of feedback to be provided, presented, or emitted at a teleoperator station. If, however, it is determined that monitoring environment conditions is not to continue, the process 600 may then end, as at 618.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow charts shown in FIGS. 4 and 6, orders in which such methods or processes are presented are not intended to be construed as any limitation on the claimed inventions, and any number of the method or process steps or boxes described herein can be omitted, reordered, or combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. A method to dynamically control a vehicle via a remote driving system, comprising:
receiving, by a processor at a teleoperator station via a communication network, environment data from an environment sensor onboard the vehicle, the vehicle being positioned within an environment remote from the teleoperator station;
determining, by the processor, friction conditions in the environment proximate the vehicle based on the environment data;
determining, by the processor, a maximum deceleration in a longitudinal movement direction of the vehicle based on the friction conditions;
receiving, by the processor from a time of flight sensor onboard the vehicle, distance data to an object in the longitudinal movement direction of the vehicle;
determining, by the processor, a maximum speed in the longitudinal movement direction based on the maximum deceleration and the distance data; and
instructing, by the processor, operation of the vehicle based at least in part on the maximum speed.

2. The method of claim 1, wherein the environment data comprises at least one of weather conditions or driving surface conditions in the environment proximate the vehicle.

3. The method of claim 1, further comprising:
receiving, by the processor from a vehicle dynamics sensor, a current speed in the longitudinal movement direction of the vehicle;
wherein instructing operation of the vehicle based at least in part on the maximum speed comprises maintaining the current speed at or below the maximum speed.

4. The method of claim 1, further comprising:
receiving, by the processor, video data from an imaging device onboard the vehicle; and
causing, by the processor via a presentation device at the teleoperator station, presentation of a notification based on the maximum speed.

5. The method of claim 4, wherein the notification comprises at least one of a visual notification, an audio notification, or a haptic notification.

6. A method, comprising:
receiving, by a processor associated with a teleoperator station via a network, environment data from an environment sensor associated with the vehicle, the vehicle being positioned within an environment remote from the teleoperator station;
determining, by the processor, friction conditions in the environment proximate the vehicle based on the environment data;
determining, by the processor, a maximum acceleration of the vehicle based at least in part on the friction conditions;
receiving, by the processor from at least one sensor associated with the vehicle, data related to at least one of a current speed of the vehicle, a distance to an object in a movement direction of the vehicle, or a current steering angle of the vehicle;
determining, by the processor, at least one dynamic control limit based on the maximum acceleration and at least one of the current speed, the distance to the object, or the current steering angle; and
instructing, by the processor, operation of the vehicle based on the at least one dynamic control limit.

7. The method of claim 6, further comprising:
receiving, by the processor, additional environment data from additional environment sensors associated with additional vehicles within the environment; and
wherein the friction conditions in the environment proximate the vehicle are further determined based on the additional environment data.

8. The method of claim 6, further comprising:
receiving, by the processor, vehicle dynamics data from the at least one sensor associated with the vehicle; and
wherein the friction conditions in the environment proximate the vehicle are further determined based on the vehicle dynamics data.

9. The method of claim 6, wherein the environment sensor comprises at least one of an optical sensor, a laser sensor, or an acoustic sensor configured to detect characteristics of at least one of tires of the vehicle or a surface of a roadway within the environment.

10. The method of claim 6, wherein the at least one sensor associated with the vehicle comprises at least one of a vehicle dynamics sensor, a radar sensor, a light detection and ranging (LIDAR) sensor, or an imaging sensor.

11. The method of claim 6, wherein the maximum acceleration comprises at least one of a maximum longitudinal deceleration or a maximum lateral acceleration; and
wherein:
the maximum longitudinal deceleration is determined based at least in part on a longitudinal coefficient of friction between tires of the vehicle and a surface of a roadway within the environment, and an acceleration due to gravity; or
the maximum lateral acceleration is determined based at least in part on a lateral coefficient of friction between the tires of the vehicle and the surface of the roadway within the environment, and the acceleration due to gravity.

12. The method of claim 11, wherein the at least one dynamic control limit comprises at least one of the maximum longitudinal deceleration, a maximum speed, a minimum stopping distance, or a maximum steering angle.

13. The method of claim 12, wherein the maximum speed is determined based at least in part on the maximum longitudinal deceleration and the distance to the object;
wherein the minimum stopping distance is determined based at least in part on the maximum longitudinal deceleration and the current speed;
wherein the maximum steering angle is determined based at least in part on the maximum lateral acceleration and the current speed; or
wherein the maximum speed is determined based at least in part on the maximum lateral acceleration and the current steering angle.

14. The method of claim 6, further comprising:
receiving, by the processor from an imaging device associated with the vehicle, video data of the environment proximate the vehicle; and
wherein instructing operation of the vehicle comprises causing, by the processor via a presentation device at the teleoperator station, presentation of a notification based on the at least one dynamic control limit with presentation of the video data;
wherein the notification comprises at least one of a visual notification, an audio notification, or a haptic notification.

15. The method of claim 6, further comprising:
providing, via an output device at the teleoperator station, feedback to a teleoperator based on the environment data of the environment proximate the vehicle;
wherein the feedback comprises at least one of visual feedback, audio feedback, or haptic feedback.

16. The method of claim 15, wherein the visual feedback comprises simulated operation of at least one of windshield wipers, defroster, or defogger based on the environment data;
wherein the audio feedback comprises simulated sound based on the environment data; or
wherein the haptic feedback comprises simulated environment characteristics at the teleoperator station based on the environment data.

17. A remote driving system, comprising:
a vehicle within an environment, the vehicle comprising an environment sensor and at least one additional sensor; and
a teleoperator station that is remote from the vehicle, the teleoperator station in communication with the vehicle via a communication network, the teleoperator station comprising a control interface, a presentation device, and a processor;
wherein the processor is configured to at least:
receive environment data from the environment sensor associated with the vehicle;
determine friction conditions in the environment proximate the vehicle based on the environment data;
determine a maximum acceleration of the vehicle based at least in part on the friction conditions;
receive, from the at least one additional sensor, data related to at least one of a current speed of the vehicle, a distance to an object in a movement direction of the vehicle, or a current steering angle of the vehicle;
determine at least one dynamic control limit based on the maximum acceleration and at least one of the current speed, the distance to the object, or the current steering angle; and
instruct operation of the vehicle based on the at least one dynamic control limit.

18. The remote driving system of claim 17, wherein the environment sensor comprises at least one of an optical sensor, a laser sensor, or an acoustic sensor; and
wherein the at least one additional sensor comprises at least one of a vehicle dynamics sensor, a radar sensor, a light detection and ranging (LIDAR) sensor, or an imaging sensor.

19. The remote driving system of claim 17, wherein the vehicle further comprises an imaging device; and
wherein the processor is further configured to:
receive, from the imaging device, video data of the environment proximate the vehicle; and
cause, via the presentation device, presentation of a notification based on the at least one dynamic control limit with presentation of the video data.

20. The remote driving system of claim 17, wherein the teleoperator station further comprises an output device; and
wherein the processor is further configured to:
provide, via the output device, feedback to a teleoperator based on the environment data of the environment proximate the vehicle;
wherein the feedback comprises at least one of visual feedback, audio feedback, or haptic feedback.
